(19) United States
(12) Patent Application Publication
(10) Pub. No.: US 2013/0129138 A1
(43) Pub. Date: May 23, 2013

(54) MULTI-FUNCTION PHONE CASE INTEGRATING RETRACTABLE EARPHONES

(71) Applicant: Booker T. Washington, JR., Chicago, IL (US)

(72) Inventor: Booker T. Washington, JR., Chicago, IL (US)

(21) Appl. No.: 13/299,260

(22) Filed: Nov. 17, 2011

(51) Int. Cl. H04R 1/10

(52) U.S. Cl. 381/384

(57) ABSTRACT

A multi-function case replaceably receiving a wireless mobile phone and having an integral retractable and extendable headset selectively connected to the wireless mobile phone. The case includes a housing, and an earbuds and plug retractor assembly. The housing replaceably receives the wireless mobile phone. The earbuds and plug retractor assembly is replaceably attached within the housing, and includes a spring-biased and ratcheted reel, a pair of earbud cords having a pair of earbuds at a pair of free ends thereof, respectively, and a plug cord having a plug at a free end thereof. The plug of the free end of the plug cord of the earbuds and plug retractor assembly is selectively connected to the wireless mobile phone. An alternate embodiment has the earbuds and plug retractor assembly being replaceably attached outside the housing.

### BACKGROUND OF THE INVENTION

1. Field of the Invention

The embodiments of the present invention relate to a case for receiving a wireless mobile phone, and more particularly, the embodiments of the present invention relate to a multi-function case for replaceably receiving a wireless mobile phone and having an integral retractable and extendable headset for selectively connecting to the wireless mobile phone.

2. Description of the Prior Art

Numerous innovations for headsets and headset retraction devices have been provided in the prior art, which will be described below in chronological order to show advancement in the art, and which are incorporated in their entirety herein by reference thereto. Even though these innovations may be suitable for the specific individual purposes to which they address, nevertheless, they differ from the present invention in that they do not teach a multi-function case for receiving a multi-function case for replaceably receiving a wireless mobile phone and having an integral retractable and extendable headset for selectively connecting to the wireless mobile phone.

(1) U.S. Pat. No. 6,082,656 to Thornton.

U.S. Pat. No. 6,082,656—issued to Thornton on Jul. 4, 2000 in U.S. class 242 and subclass 385.4—teaches a cord retraction assembly for an electronic device, which includes a reel for winding and retracting the cord, a catch element adapted to engage the reel to prevent retraction of the cord, and an interlock for disabling the catch element when the cord is wound unto the reel. The catch element is urged into engagement with the reel by a spring to prevent retraction of the cord during use. A release button disengages the catch element from the reel allowing the cord to retract. The interlock includes a pivotally-mounted arm that rides over the cord as the cord accumulates on the reel. The accumulation of the cord on the reel pushes the arm outward into engagement with the catch element so as to prevent the catch element from moving back to the engaged position. As the cord is unwound from the reel, the catch element is able to return to the engaged position.

(2) U.S. Pat. No. 6,285,757 to Carroll et al.

U.S. Pat. No. 6,285,757—issued to Carroll et al. on Sep. 4, 2001 in U.S. class 345 and subclass 619—teaches a body-wearable interactive device with a retractable earbud and a microphone provides data, audio and voice communication with a wearable personal computing or other remote device. Full voice and display interface with a personal computer can be achieved with the use of a wireless link between the input/output device and computer. The device is adapted for use with a variety of ancillary communications devices to provide flexibility in field and mobile communications scenarios. Corresponding methods are also taught by which a wearer can effect communication through and with the interactive device.

### (3) U.S. Patent Application Publication No. 2001/0035242 to Hughs et al.

United States Patent Application Publication Number 2001/0035242—published to Hughs et al. on Nov. 1, 2001 in U.S. class 150 and subclass 154—teaches an assembly including a case for protecting a mobile wireless phone with a retractable headset device installed in an integral pocket. Openings in the case are provided for extending a connector cable that is plugged into the wireless phone, and for retractably extracting an earphone segment. The earphone cable segment is extracted for use when using the wireless phone in a hands-free scenario, and retracted when the assembly is to be stored.

(4) U.S. Pat. No. D457,516 to Kohli et al.

U.S. Pat. No. D457,516—issued to Kohli et al. on May 21, 2002 in U.S. class D14 and subclass 224—teaches the ornamental design for a retractable headset housing.

(5) U.S. Pat. No. 6,633,770 to Gitzinger et al.

U.S. Pat. No. 6,633,770—issued to Gitzinger et al. on Oct. 14, 2003 in U.S. class 455 and subclass 575.1—teaches a holster for a telecommunication device, such as a cellular telephone or wireless telephone, which includes a housing adapted to removably support the telecommunication device. The holster also includes an earpiece assembly including at least one transducer, such as an earbud or a microphone, and a cord depending from the at least one transducer. The earpiece assembly is extendable and retractable relative to the housing. The holster further includes an extension/retraction assembly having a spool for taking up at least a portion of the cord when the earpiece assembly is retracted relative to the housing, and at least one coil spring adapted to rotate the spool. The at least one coil spring can electrically couple the at least one transducer to the telecommunication device.

### (6) U.S. Patent Application Publication No. 2005/0153 750 to Gantz et al.

United States Patent Application Publication Number 2005/0153750—published to Gantz et al. on Jul. 14, 2005 in U.S. class 455 and subclass 569.1—teaches a hands-free personal communication device that is worn about a user's neck. The communication device includes an elongated and elastic neckband for supporting the communication device about the user's neck. The elastic neckband has memory characteristics, and is bendable along its length so that the neckband is formable into and out of various selectable positions. An acoustic output device is attached to the neckband, and positioned near an ear of the user when the communication device is worn about the user's neck. A microphone is attached to an end of the neckband. A detachable earbud may be attached to an end of the neckband.

### (7) U.S. Patent Application Publication No. 2006/0286932 to Sakhpara.

U.S. Patent Application Publication No. 2006/0286932—published to Sakhpara on Dec. 21, 2006 in U.S. class 455 and subclass 41.1—teaches a headset system for an audio playback system. The headset system is integrated into the audio playback system, and includes a headset, a cord compartment, and a cord retractor. The headset includes an earbud that is operable to provide audio information, and a cord that is operable to couple the headset to the audio playback system. The cord compartment is operable to store the cord in the audio playback system. The cord is also operable to be pulled from the cord compartment. The cord retractor is coupled to the cord compartment, and is operable to retract the cord into the cord compartment.

### (8) U.S. Patent Application Publication No. 2007/0121985 to Park.

U.S. Patent Application Publication No. 2007/0121985—published to Park on May 31, 2007 in U.S. class 381 and subclass 374—teaches a headset with a retractable cord for portable devices with an automatic switching capability system. The headset includes an electronic device, a headset, a cord extending between the electronic device and the headset, and a retracting assembly for retracting the cord into a coil during periods of non-use. Optionally, the system includes a retraction detection assembly for determining a condition of retraction of the cord with respect to the electronic device.

### (9) U.S. Patent Application Publication No. 2007/0165371 to Brandenburg.

U.S. Patent Application Publication No. 2007/0165371—published to Brandenburg on Jul. 19, 2007 in U.S. class 361 and subclass 679.55—teaches a portable digital media player case including a front surface having at least one viewing window, a rear surface opposite the front surface, side surfaces, and top and bottom surfaces. A winder is movable into and out of one of the surfaces, preferably, the rear surface, between a closed storage position and an open position for receiving a cord.

### (10) U.S. Patent Application Publication No. 2010/0128916 to Bradford et al.

U.S. Patent Application Publication No. 2010/0128916—published to Bradford et al. on May 27, 2010 in U.S. class 381 and subclass 386—teaches an earbud headset, a handset including the same, and methods of operating the headset and handset. In one embodiment, the earbud headset includes a speaker portion that is retractable into and extendable from a base portion, thereby allowing for a thin profile form factor.

It is apparent that numerous innovations for headsets and headset retraction devices have been provided in the prior art, which are adapted to be used. Furthermore, even though these innovations may be suitable for the specific individual purposes to which they address, nevertheless, they would not be suitable for the purposes of the embodiments of the present invention as heretofore described, namely, a multi-function case for replaceably receiving a wireless mobile phone and having an integral retractable and extendable headset for selectively connecting to the wireless mobile phone.

### SUMMARY OF THE INVENTION

Thus, an object of the embodiments of the present invention is to provide a multi-function case for replaceably receiving a wireless mobile phone and having an integral retractable and extendable headset for selectively connecting to the wireless mobile phone, which avoids the disadvantages of the prior art.

Briefly stated, another object of the embodiments of the present invention is to provide a multi-function case replaceably receiving a wireless mobile phone and having an integral retractable and extendable headset selectively connected to the wireless mobile phone. The case includes a housing and an earbuds and plug retractor assembly. The housing replaceably receives the wireless mobile phone. The earbuds and plug retractor assembly is replaceably attached within the housing, and includes a spring-biased and ratcheted reel, a pair of earbud cords having a pair of earbuds at a pair of free ends thereof, respectively, and a plug cord having a plug at a free end thereof. The plug of the free end of the plug cord of the earbuds and plug retractor assembly is selectively connected to the wireless mobile phone. The spring-biased and ratcheted reel of the earbuds and plug retractor assembly selectively and windingly retracts and unwindingly extends the pair of earbud cords of the earbuds and plug retractor assembly and the plug cord of the earbuds and plug retractor assembly. An alternate embodiment has the earbuds and plug retractor assembly being replaceably attached outside the housing.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying figures of the drawing.

### BRIEF DESCRIPTION OF THE FIGURES OF THE DRAWING

The figures of the drawing are briefly described as follows:

FIG. 1 is a diagrammatic perspective view of a first embodiment of the multi-function case of the embodiments of the present invention replaceably receiving a wireless mobile phone and having an integral retractable and extendable headset selectively connected to the wireless mobile phone;

FIG. 2 is an enlarged diagrammatic perspective view of the area generally enclosed by the dotted curve identified by ARROW 2 in FIG. 1 of the multi-function case of the embodiments of the present invention replaceably receiving a wireless mobile phone and having an integral retractable and extendable headset selectively connected to the wireless mobile phone;

FIG. 3 is a reduced and exploded diagrammatic perspective view of the multi-function case of the embodiments of the present invention shown in FIG. 2 replaceably receiving a wireless mobile phone and having an integral retractable and extendable headset selectively connected to the wireless mobile phone;

FIG. 4 is a reduced diagrammatic perspective view of the multi-function case of the embodiments of the present invention shown in FIG. 2 replaceably receiving a wireless mobile phone and having an integral retractable and extendable headset selectively connected to the wireless mobile phone with the earbuds of the retractable and extendable headset of the multi-function case of the embodiments of the present invention being extended therefrom;

FIG. 5 is a reduced diagrammatic perspective view of the multi-function case of the embodiments of the present invention shown in FIGURE 2 replaceably receiving a wireless mobile phone and having an integral retractable and extendable headset selectively connected to the wireless mobile phone with the plug of the retractable and extendable headset of the multi-function case of the embodiments of the present invention being extended therefrom and in the process of engaging the wireless mobile phone;

FIG. 6 is a reduced diagrammatic perspective view of the multi-function case of the embodiments of the present invention shown in FIG. 2 sans the wireless mobile phone and being also used to hide valuables such as money;

FIG. 7 is an enlarged diagrammatic side elevational view taken in the direction of ARROW 7 in FIG. 6 of the multi-function case of the embodiments of the present invention;

FIG. 8 is a reduced diagrammatic perspective view of the multi-function case of the embodiments of the present invention shown in FIG. 7;

FIG. 8A is an exploded diagrammatic perspective view of the multi-function case of the embodiments of the present invention shown in FIG. 8;

FIG. 9 is an enlarged diagrammatic cross sectional view taken along LINE 9-9 in FIG. 8A;

FIG. 10 is a diagrammatic block diagram of the earbuds and plug retractor assembly of the multi-function case of the embodiments of the present invention identified by ARROW 10 in FIG. 9;

FIG. 11 is a diagrammatic perspective view of an alternate embodiment of the multi-function case of the embodiments of the present invention replaceably receiving a wireless mobile phone and having an integral retractable and extendable headset selectively connected to the wireless mobile phone;

FIG. 12 is an enlarged diagrammatic perspective view of the area generally enclosed by the dotted curve identified by ARROW 12 in FIG. 11 of the multi-function case of the embodiments of the present invention replaceably receiving a wireless mobile phone and having an integral retractable and extendable headset selectively connected to the wireless mobile phone;

FIG. 13 is a reduced and exploded diagrammatic perspective view of the multi-function case of the embodiments of the present invention shown in FIG. 12 replaceably receiving a wireless mobile phone and having an integral retractable and extendable headset selectively connected to the wireless mobile phone;

FIG. 14 is a reduced diagrammatic perspective view of the multi-function case of the embodiments of the present invention shown in FIG. 12 replaceably receiving a wireless mobile phone and having an integral retractable and extendable headset selectively connected to the wireless mobile phone with the earbuds of the retractable and extendable headset of the multi-function case of the embodiments of the present invention being extended therefrom;

FIG. 15 is a reduced and exploded diagrammatic perspective view of the multi-function case of the embodiments of the present invention shown in FIG. 12 replaceably receiving a wireless mobile phone and having an integral retractable and extendable headset selectively connected to the wireless mobile phone with the plug of the retractable and extendable headset of the multi-function case of the embodiments of the present invention being extended therefrom and in the process of engaging the wireless mobile phone;

FIG. 16 is a reduced diagrammatic perspective view of the multi-function case shown in FIG. 12 sans the wireless mobile phone, and being also used to hide valuables such as money;

FIG. 17 is an enlarged diagrammatic side elevational view of the multi-function case of the embodiments of the present invention shown in FIG. 16;

FIG. 18 is a diagrammatic perspective view of the multi-function case shown in FIG. 17;

FIG. 18A is an exploded diagrammatic perspective view of the multi-function case of the embodiments of the present invention shown in FIG. 18; and

FIG. 19 is an enlarged diagrammatic cross sectional view taken along LINE 19-19 in FIG. 18.

### LIST OF REFERENCE NUMERALS UTILIZED IN THE FIGURES OF THE DRAWING

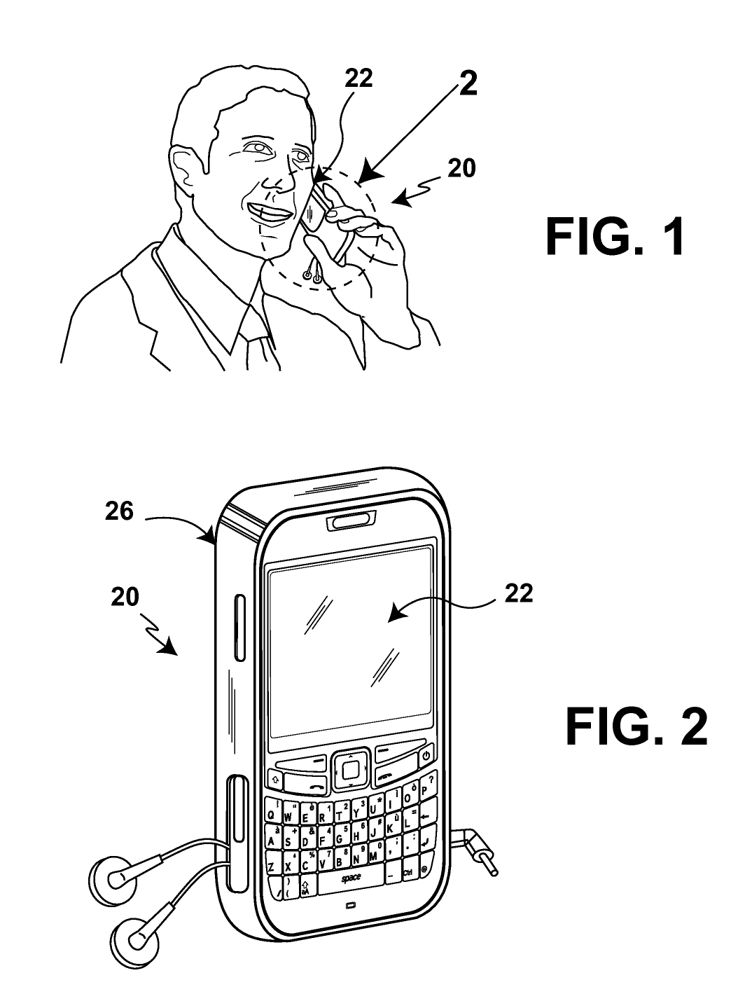

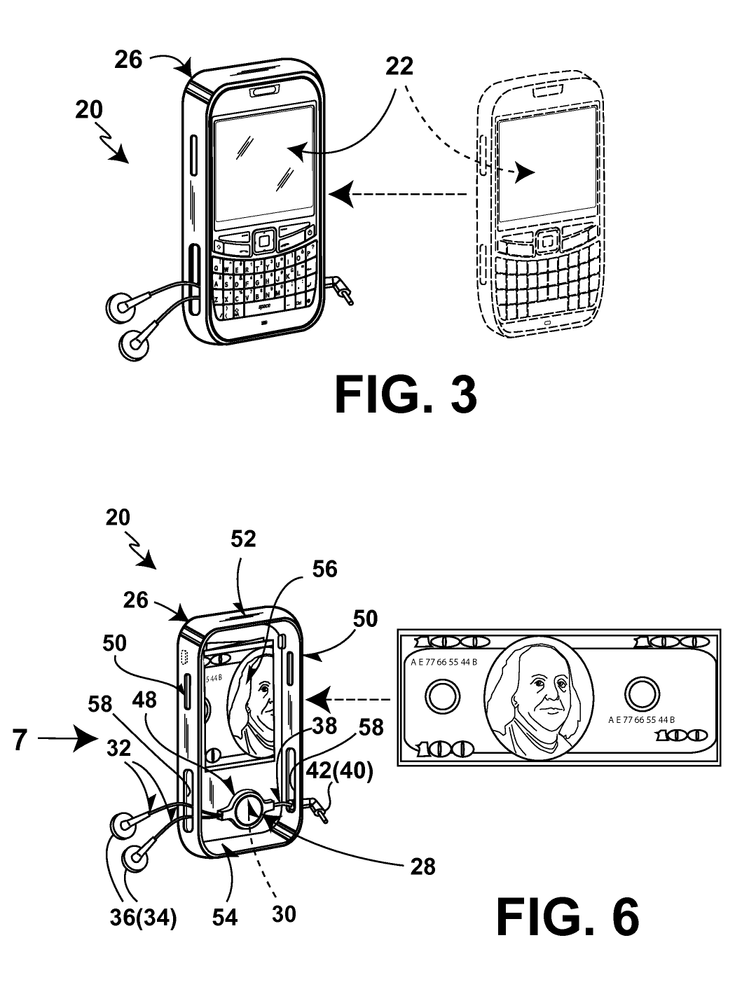

### A. General—FIGS. 1-5.

20 multi-function case of embodiments of present invention for replaceably receiving wireless mobile phone 22 and having integral retractable and extendable headset for selectively connecting to wireless mobile phone 22

22 wireless mobile phone

B. Configuration of first embodiment of multi-function case 20—FIGS. 6-8, 8A, 9, and 10.

26 housing for replaceably receiving wireless mobile phone 22

28 earbuds and plug retractor assembly

30 spring-biased and ratcheted reel of earbuds and plug retractor assembly 28

32 pair of earbud cords of earbuds and plug retractor assembly 28

34 pair of earbuds of pair of free ends 36 of pair of earbud cords 32 of earbuds and plug retractor assembly 28, respectively

36 pair of free ends of pair of earbud cords 32 of earbuds and plug retractor assembly 28, respectively

38 plug cord of earbuds and plug retractor assembly 28

40 plug of free end 42 of plug cord 38 of earbuds and plug retractor assembly 28 for selectively connecting to wireless mobile phone 22

42 free end of plug cord 38 of earbuds and plug retractor assembly 28

43 housing of earbuds and plug retractor assembly 28

44 coil spring of earbuds and plug retractor assembly 28

46 ratchet of earbuds and plug retractor assembly 28

48 rear wall of housing 26

50 pair of side walls of housing 26

52 top wall of housing 26

54 bottom wall of housing 26

56 open front of housing 26

58 pair of through slots of pair of side walls 50 of housing 26, respectively

60 pair of mating snap parts of earbuds and plug retractor assembly 28

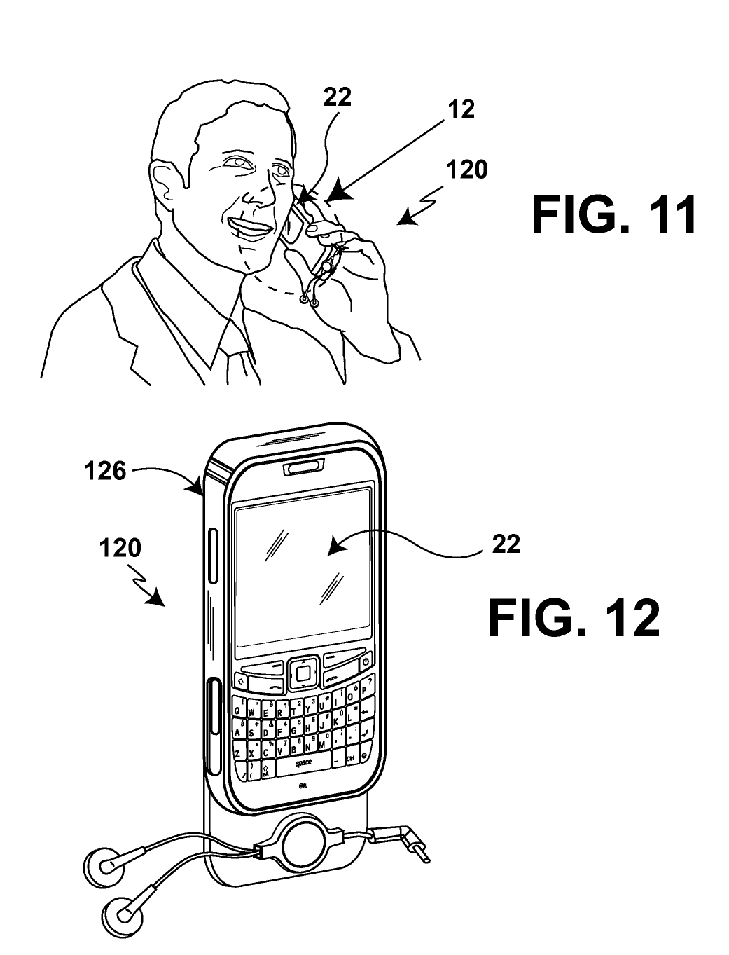

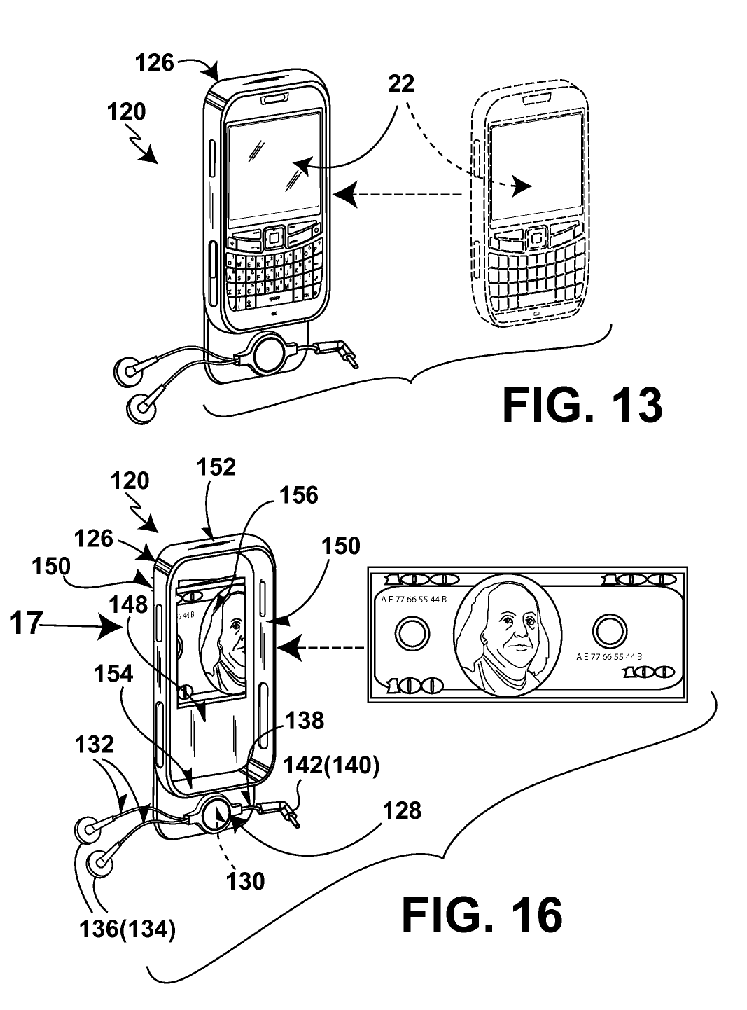

C. Configuration of second embodiment of multi-function case 120—FIGS. 11-18, 18A, and 19.

120 multi-function case of embodiments of the present invention

126 housing for replaceably receiving wireless mobile phone 22

128 earbuds and plug retractor assembly

130 spring-biased and ratcheted reel of earbuds and plug retractor assembly 128

132 pair of earbud cords of earbuds and plug retractor assembly 128

134 pair of earbuds of pair of free ends 136 of pair of earbud cords 132 of earbuds and plug retractor assembly 128, respectively

136 pair of free ends of pair of earbud cords 132 of earbuds and plug retractor assembly 128, respectively

138 plug cord of earbuds and plug retractor assembly 128

140 plug of free end 142 of plug cord 138 of earbuds and plug retractor assembly 128 for selectively connecting to wireless mobile phone 22

142 free end of plug cord 138 of earbuds and plug retractor assembly 128

143 housing of earbuds and plug retractor assembly 128

144 coil spring of earbuds and plug retractor assembly 128

146 ratchet of earbuds and plug retractor assembly 128

148 rear wall of housing 126

150 pair of side walls of housing 126

152 top wall of housing 126

154 bottom wall of housing 126

156 open front of housing 126

160 pair of mating snap parts of earbuds and plug retractor assembly 128

162 mounting plate of earbuds and plug retractor assembly 128

### DETAILED DESCRIPTION OF THE PREFERRED EMBODIMENTS

### General

Referring now to the figures, in which like numerals indicate like parts, and particularly to FIGS. 1-5, which are, respectively, a diagrammatic perspective view of a first embodiment of the multi-function case of the embodiments of the present invention replaceably receiving a wireless mobile phone and having an integral retractable and extendable headset selectively connected to the wireless mobile phone, an enlarged diagrammatic perspective view of the area generally enclosed by the dotted curve identified by ARROW 2 in FIG. 1 of the multi-function case of the embodiments of the present invention replaceably receiving a wireless mobile phone and having an integral retractable and extendable headset selectively connected to the wireless mobile phone, a reduced and exploded diagrammatic perspective view of the multi-function case of the embodiments of the present invention shown in FIG. 2 replaceably receiving a wireless mobile phone and having an integral retractable and extendable headset selectively connected to the wireless mobile phone, a reduced diagrammatic perspective view of the multi-function case of the embodiments of the present invention shown in FIG. 2 replaceably receiving a wireless mobile phone and having an integral retractable and extendable headset selectively connected to the wireless mobile phone with the earbuds of the retractable and extendable headset of the multi-function case of the embodiments of the present invention being extended therefrom, and a reduced diagrammatic perspective view of the multi-function case of the embodiments of the present invention shown in FIG. 2 replaceably receiving a wireless mobile phone and having an integral retractable and extendable headset selectively connected to the wireless mobile phone with the plug of the retractable and extendable headset of the multi-function case of the embodiments of the present invention being extended therefrom and in the process of engaging the wireless mobile phone, the multi-function case of the embodiments of the present invention is shown generally at 20 for replaceably receiving a wireless mobile phone 22 and having an integral retractable and extendable headset for selectively connecting to the wireless mobile phone 22.

### Configuration of a First Embodiment of the Multi-Function Case 20

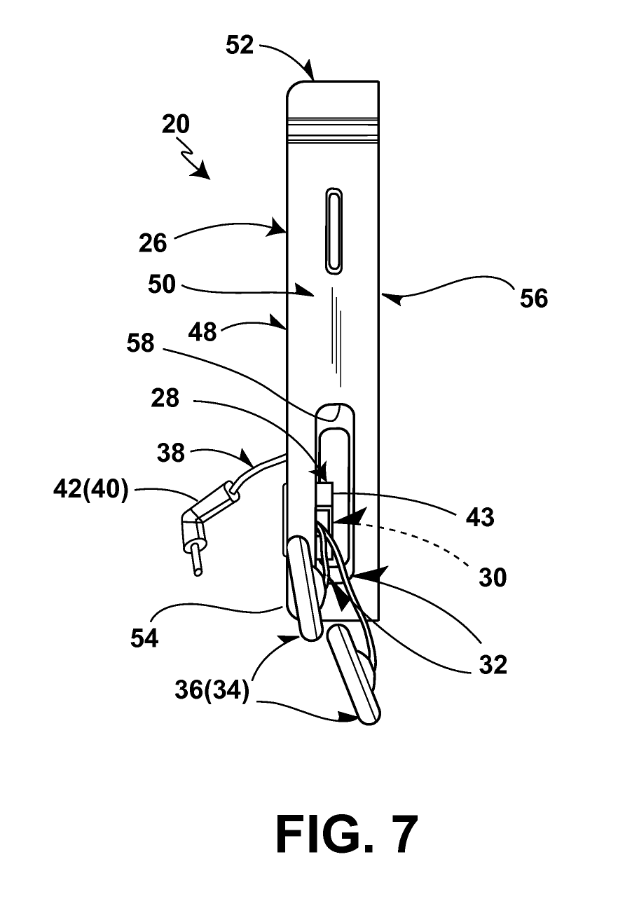

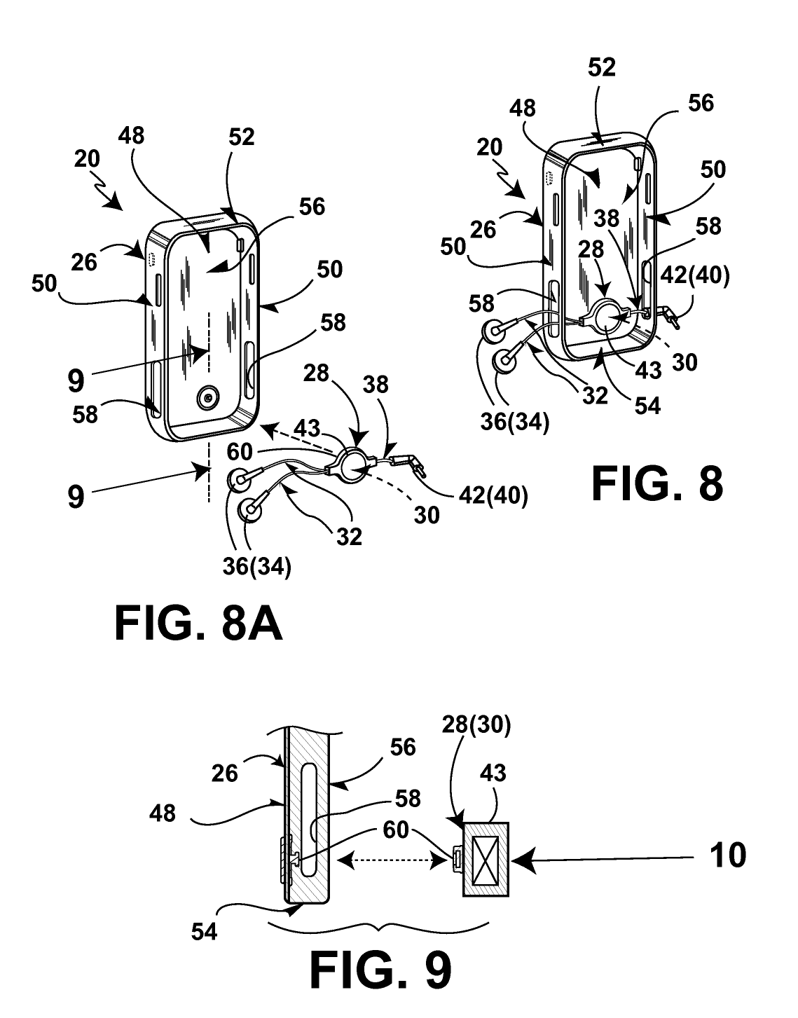

The configuration of the multi-function case 20 best be seen in FIGS. 6-8, 8A, 9, and 10, which are, respectively, a reduced diagrammatic perspective view of the multi-function case of the embodiments of the present invention shown in FIG. 2 sans the wireless mobile phone and being also used to hide valuables such as money, an enlarged diagrammatic side elevational view taken in the direction of ARROW 7 in FIG. 6 of the multi-function case of the embodiments of the present invention, a reduced diagrammatic perspective view of the multi-function case of the embodiments of the present invention shown in FIG. 7, an exploded diagrammatic perspective view of the multi-function case of the embodiments of the present invention shown in FIG. 8, an enlarged diagrammatic cross sectional view taken along LINE 9-9 in FIG. 8A, and a diagrammatic block diagram of the earbuds and plug retractor assembly of the multi-function case of the embodiments of the present invention identified by ARROW 10 in FIG. 9, and as such, will be discussed with reference thereto.

The multi-function case 20 comprises a housing 26, and an earbuds and plug retractor assembly 28.

The housing 26 is for replaceably receiving the wireless mobile phone 22 (FIGS. 2, 3, 4, and 5).

The earbuds and plug retractor assembly 28 is replaceably attached within the housing 26 so as to be internal to the housing 26. The earbuds and plug retractor assembly 28 includes a spring-biased and ratcheted reel 30, a pair of earbud cords 32 having a pair of earbuds 34 at a pair of free ends 36 thereof, respectively, and a plug cord 38 having a plug 40 at a free end 42 thereof.

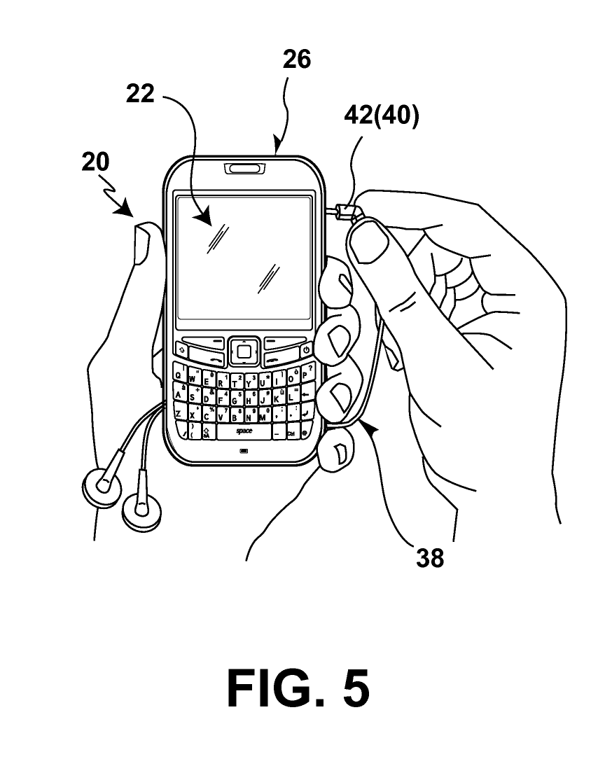

The plug 40 of the free end 42 of the plug cord 38 of the earbuds and plug retractor assembly 28 is for selectively connecting to the wireless mobile phone 22 (FIG. 5).

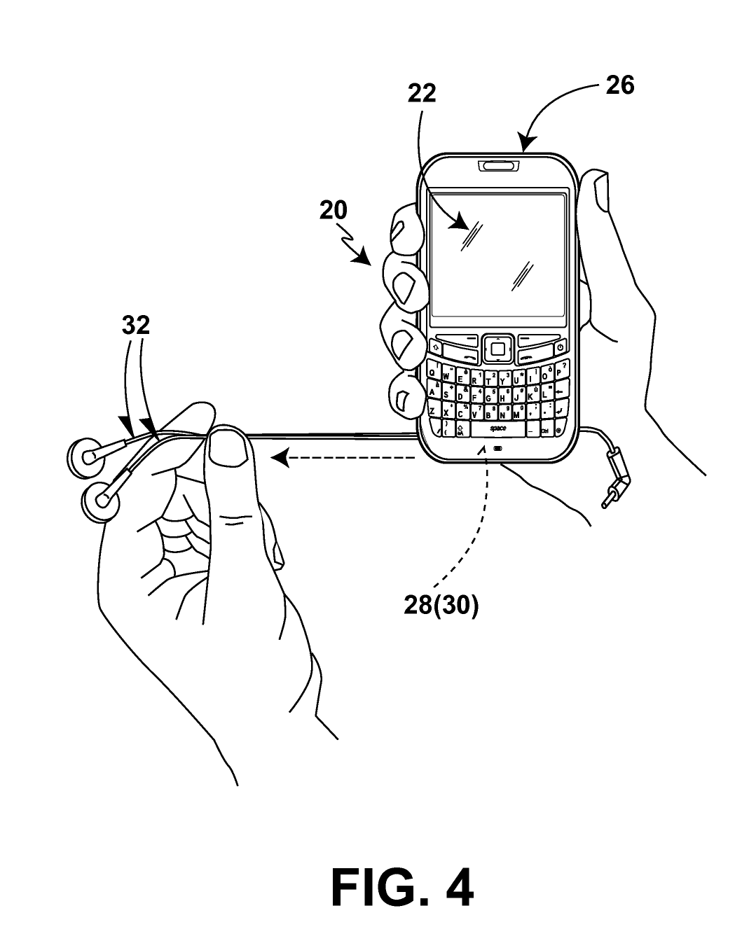

The spring-biased and ratcheted reel 30 of the earbuds and plug retractor assembly 28 selectively and windingly retracts and unwindingly extends the pair of earbud cords 32 of the earbuds and plug retractor assembly 28 (FIG. 4) and the plug cord 38 of the earbuds and plug retractor assembly 28.

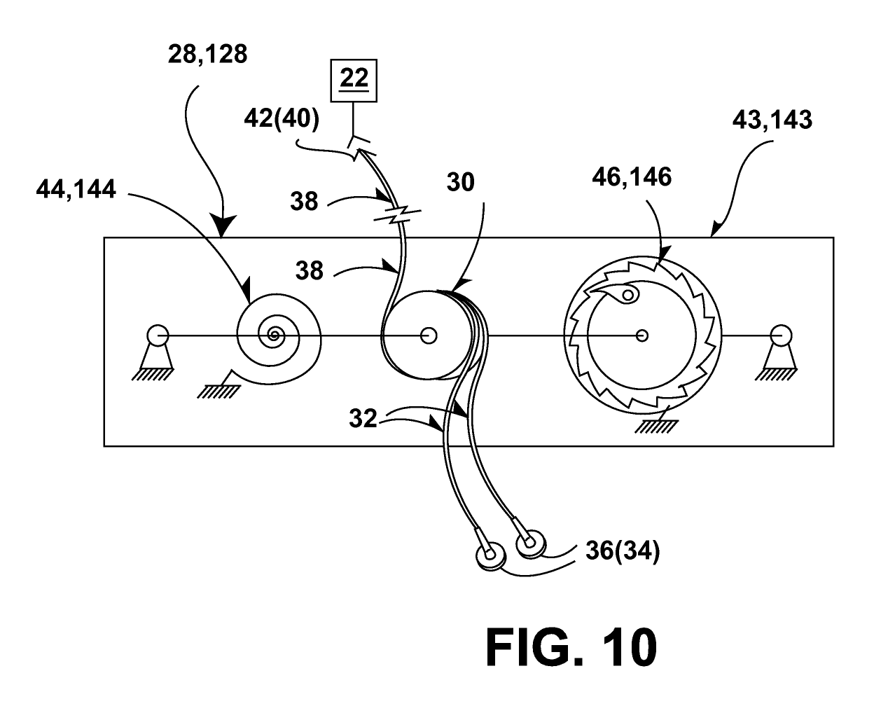

As further shown in FIG. 10, the earbuds and plug retractor assembly 28 further includes a housing 43, a coil spring 44, and a ratchet 46. The coil spring 44 of the earbuds and plug retractor assembly 28 and the ratchet 46 of the earbuds and plug retractor assembly 28 are contained within the housing 43 of the earbuds and plug retractor assembly 28, and are operatively connected to the spring-biased and ratcheted reel 30 of the earbuds and plug retractor assembly 28.

The housing 26 has a rear wall 48, a pair of side walls 50, a top wall 52, a bottom wall 54, and an open front 56.

The pair of side walls 50 of the housing 26 have a pair of through slots 58, respectively. The pair of through slots 58 of the pair of side walls 50 of the housing 26, respectively, are in close proximity to the bottom wall 54 of the housing 26. One of the pair of through slots 58 of one of the pair of side walls 50 of the housing 26 has the pair of earbud cords 32 of the earbuds and plug retractor assembly 28 extending therethrough, while the other of the pair of through slots 58 of the other of the pair of side walls 50 of the housing 26 has the plug cord 38 of the earbuds and plug retractor assembly 28 extending therethrough.

As shown in FIGS. 8A and 9, the housing 43 of the earbuds and plug retractor assembly 28 is replaceably attached within the housing 26, so as to be internal to the housing 26, by a pair of mating snap parts 60.

One of the pair of mating snap parts 60 of the earbuds and plug retractor assembly 28 is affixed to the rear wall 48 of the housing 26, is centered between the pair of side walls 50 of the housing 26, and is just above the bottom wall 54 of the housing 26, while the other of the pair of mating snap parts 60 of the earbuds and plug retractor assembly 28 is affixed to the housing 43 of the earbuds and plug retractor assembly 28.

### Configuration of a Second Embodiment of the Multi-Function Case 120

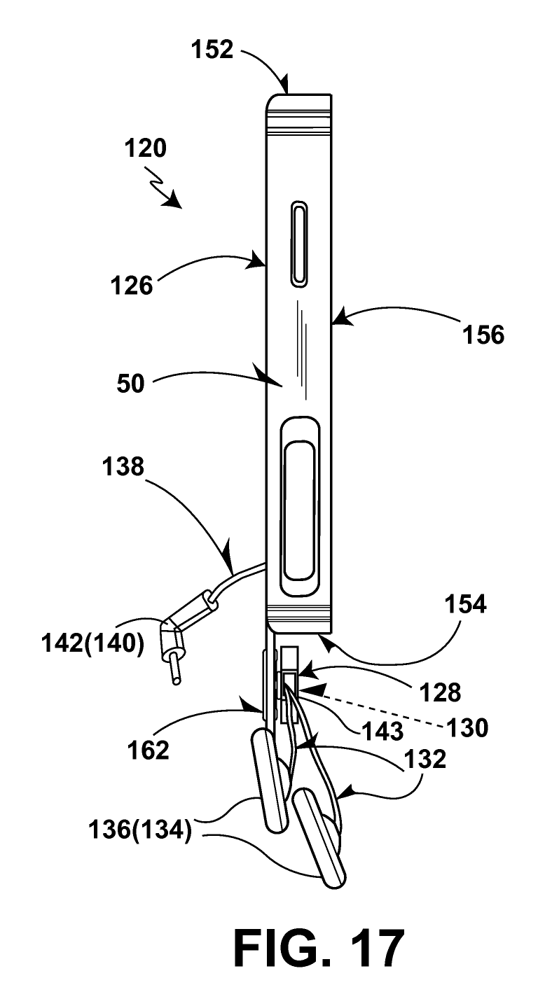

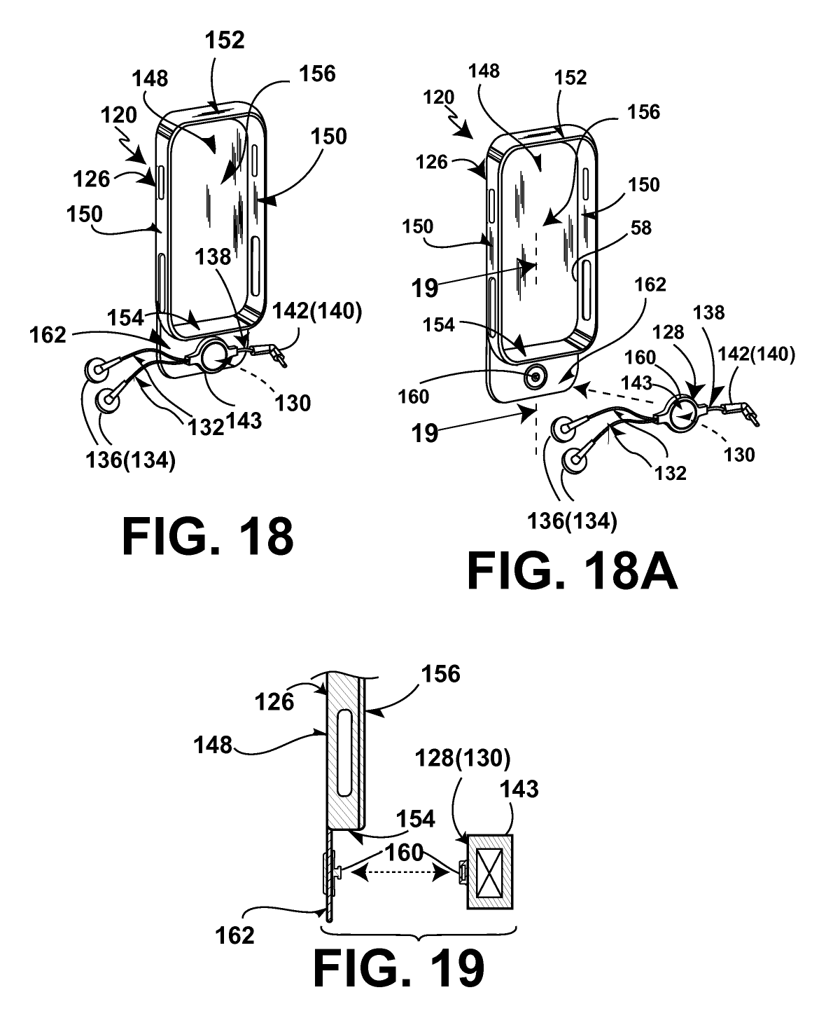

The configuration of the multi-function case 120 can best be seen in FIGS. 11-18, 18A, and 19, which are, respectively, a diagrammatic perspective view of an alternate embodiment of the multi-function case of the embodiments of the present invention replaceably receiving a wireless mobile phone and having an integral retractable and extendable headset selectively connected to the wireless mobile phone, an enlarged diagrammatic perspective view of the area generally enclosed by the dotted curve identified by ARROW 12 in FIG. 11 of the multi-function case of the embodiments of the present invention replaceably receiving a wireless mobile phone and having an integral retractable and extendable headset selectively connected to the wireless mobile phone, a reduced and exploded diagrammatic perspective view of the multi-function case of the embodiments of the present invention shown in FIG. 12 replaceably receiving a wireless mobile phone and having an integral retractable and extendable headset selectively connected to the wireless mobile phone, a reduced diagrammatic perspective view of the multi-function case of the embodiments of the present invention shown in FIG. 12 replaceably receiving a wireless mobile phone and having an integral retractable and extendable headset selectively connected to the wireless mobile phone with the earbuds of the retractable and extendable headset of the multi-function case of the embodiments of the present invention being extended therefrom, a reduced and exploded diagrammatic perspective view of the multi-function case of the embodiments of the present invention shown in FIG. 12 replaceably receiving a wireless mobile phone and having an integral retractable and extendable headset selectively connected to the wireless mobile phone with the plug of the retractable and extendable headset of the multi-function case of the embodiments of the present invention being extended therefrom and in the process of engaging the wireless mobile phone, a reduced diagrammatic perspective view of the multi-function case shown in FIG. 12 sans the wireless mobile phone, and being also used to hide valuables such as money, an enlarged diagrammatic side elevational view of the multi-function case of the embodiments of the present invention shown in FIG. 16, a diagrammatic perspective view of the multi-function case shown in FIG. 17, an exploded diagrammatic perspective view of the multi-function case of the embodiments of the present invention shown in FIG. 18, and an enlarged diagrammatic cross sectional view taken along LINE 19-19 in FIG. 18, and as such, will be discussed with reference thereto.

The multi-function case 120 comprises a housing 126, and an earbuds and plug retractor assembly 128.

The housing 126 is for replaceably receiving the wireless mobile phone 22 (FIGS. 12, 13, 14, and 15).

The earbuds and plug retractor assembly 128 is replaceably attached below, and external to, the housing 126.

The earbuds and plug retractor assembly 128 includes a spring-biased and ratcheted reel 130, a pair of earbud cords 132 having a pair of earbuds 134 at a pair of free ends 136 thereof, respectively, and a plug cord 138 having a plug 140 at a free end 142 thereof.

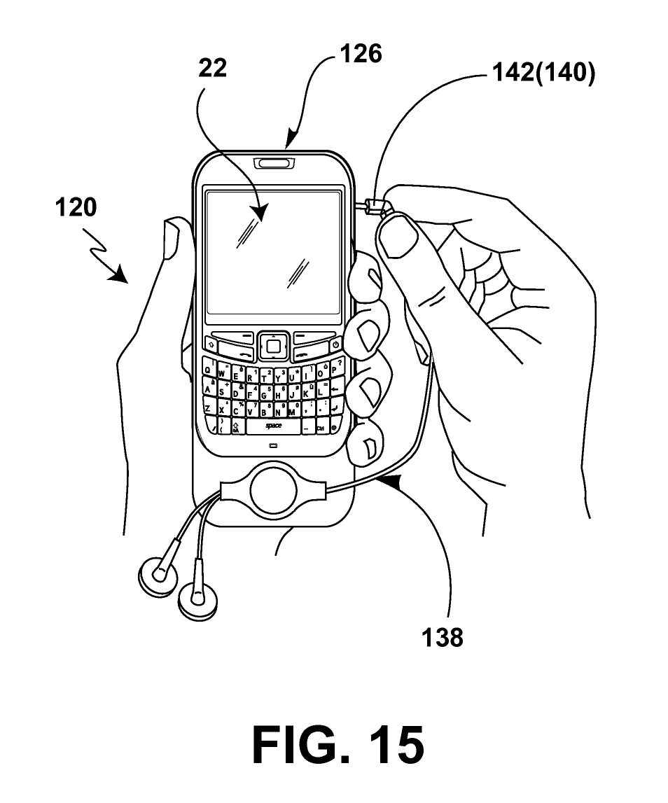

The plug 140 of the free end 142 of the plug cord 138 of the earbuds and plug retractor assembly 128 is for selectively connecting to the wireless mobile phone 22 (FIG. 15).

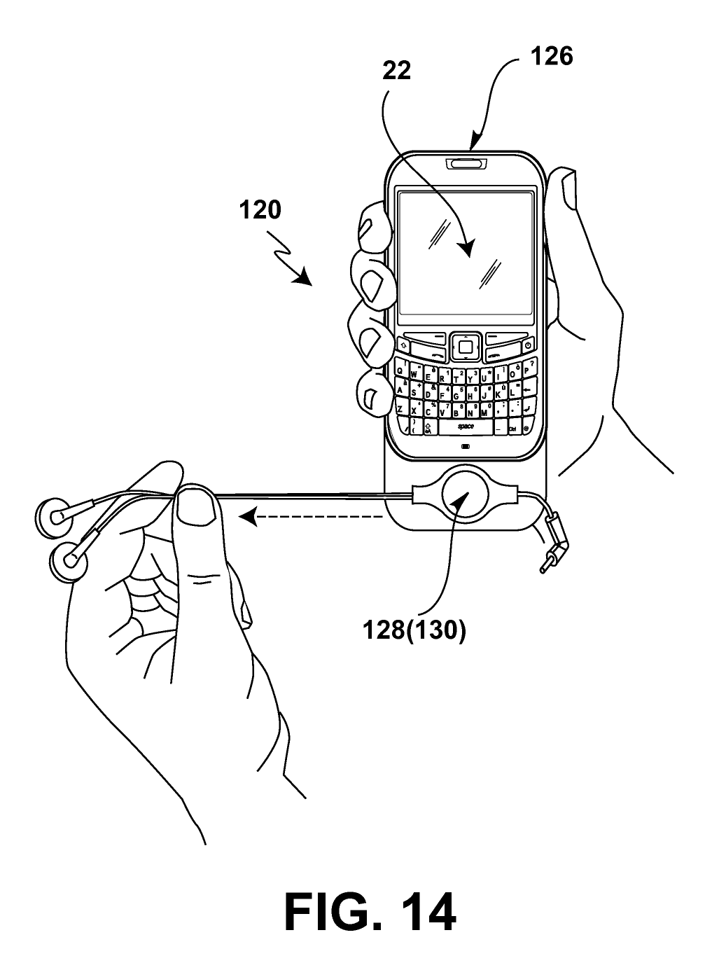

The spring-biased and ratcheted reel 130 of the earbuds and plug retractor assembly 128 selectively and windingly retracts and unwindingly extends the pair of earbud cords 132 of the earbuds and plug retractor assembly 128 (FIG. 14) and the plug cord 138 of the earbuds and plug retractor assembly 128.

As also shown in FIG. 10, the earbuds and plug retractor assembly 128 includes a housing 143, a coil spring 144, and a ratchet 146. The coil spring 144 of the earbuds and plug retractor assembly 128 and the ratchet 146 of the earbuds and plug retractor assembly 128 are contained within the housing 143 of the earbuds and plug retractor assembly 128, and are operatively connected to the spring-biased and ratcheted reel 130 of the earbuds and plug retractor assembly 128.

The housing 126 has a rear wall 148, a pair of side walls 150, a top wall 152, a bottom wall 154, and an open front 156.

The earbuds and plug retractor assembly 128 further has a mounting plate 162. The mounting plate 162 of the earbuds and plug retractor assembly 128 depends from the bottom wall 154 of the housing 126, and is generally coplanar with the rear wall 148 of the housing 126.

As shown in FIGS. 18A and 19, the housing 143 of the earbuds and plug retractor assembly 128 is replaceably attached to the mounting plate 162 of the earbuds and plug retractor assembly 128, and is thereby external to the housing 126, by a pair of mating snap parts 160.

One of the pair of mating snap parts 160 of the earbuds and plug retractor assembly 128 is affixed to the mounting plate 162 of the earbuds and plug retractor assembly 128, generally centered thereon, while the other of the pair of mating snap parts 160 of the earbuds and plug retractor assembly 128 is affixed to the housing 143 of the earbuds and plug retractor assembly 128.

### Impressions

It will be understood that each of the elements described above or two or more together may also find a useful application in other types of constructions differing from the types described above.

While the embodiments of the present invention have been illustrated and described as embodied in a multi-function case for replaceably receiving a wireless mobile phone and having an integral retractable and extendable headset for selectively connecting to the telecommunication device, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

1. A multi-function case for replaceably receiving a wireless mobile phone and having an integral retractable and extendable headset for selectively connecting to the wireless mobile phone, comprising:
a) a housing; and
b) an earbuds and plug retractor assembly;
wherein said housing is for replaceably receiving the wireless mobile phone;
wherein said earbuds and plug retractor assembly is replaceably attached within said housing so as to be internal to said housing;
wherein said earbuds and plug retractor assembly includes:
a) a spring-biased and ratcheted reel;
b) a pair of earbud cords having a pair of earbuds at a pair of free ends thereof, respectively; and
c) a plug cord having a plug at a free end thereof;
wherein said plug of said free end of said plug cord of said earbuds and plug retractor assembly is for selectively connecting to the wireless mobile phone; and
wherein said spring-biased and ratcheted reel of said earbuds and plug retractor assembly selectively and windingly retracts and unwindingly extends said pair of earbud cords of said earbuds and plug retractor assembly and said plug cord of said earbuds and plug retractor assembly.

2. The case of claim 1, wherein said earbuds and plug retractor assembly includes a housing.

3. The case of claim 2, wherein said earbuds and plug retractor assembly includes a coil spring.

4. The case of claim 3, wherein said earbuds and plug retractor assembly includes a ratchet.

5. The case of claim 4, wherein said coil spring of said earbuds and plug retractor assembly and said ratchet of said earbuds and plug retractor assembly are contained within said housing of said earbuds and plug retractor assembly.

6. The case of claim 5, wherein said coil spring of said earbuds and plug retractor assembly and said ratchet of said earbuds and plug retractor assembly are operatively connected to said spring-biased and ratcheted reel of said earbuds and plug retractor assembly.

7. The case of claim 2, wherein said housing has:
a) a rear wall;
b) a pair of side walls;
c) a top wall;
d) a bottom wall; and
e) an open front.

8. The case of claim 7, wherein said pair of side walls of said housing have a pair of through slots, respectively.

9. The case of claim 8, wherein said pair of through slots of said pair of side walls of said housing, respectively, are in close proximity to said bottom wall of said housing.

10. The case of claim 8, wherein one of said pair of through slots of one of said pair of side walls of said housing has said pair of earbud cords of said earbuds and plug retractor assembly extending therethrough, while the other of said pair of through slots of the other of said pair of side walls of said housing has said plug cord of said earbuds and plug retractor assembly extending therethrough.

11. The case of claim 7, wherein said housing of said earbuds and plug retractor assembly is replaceably attached within said housing, so as to be internal to said housing, by a pair of mating snap parts.

12. The case of claim 11, wherein one of said pair of mating snap parts of said earbuds and plug retractor assembly is affixed to said rear wall of said housing;
wherein said one of said pair of mating snap parts of said earbuds and plug retractor assembly is centered between said pair of side walls of said housing;
wherein said one of said pair of mating snap parts of said earbuds and plug retractor assembly is just above said bottom wall of said housing; and
wherein the other of said pair of mating snap parts of said earbuds and plug retractor assembly is affixed to said housing of said earbuds and plug retractor assembly.

13. A multi-function case for replaceably receiving a wireless mobile phone and having an integral retractable and extendable headset for selectively connecting to the wireless mobile phone, comprising:
a) a housing; and
b) an earbuds and plug retractor assembly;
wherein said housing is for replaceably receiving the wireless mobile phone;
wherein said earbuds and plug retractor assembly is replaceably attached below said housing so as to be external to said housing;
wherein said earbuds and plug retractor assembly includes:
a) a spring-biased and ratcheted reel;
b) a pair of earbud cords having a pair of earbuds at a pair of free ends thereof, respectively; and
c) a plug cord having a plug at a free end thereof;
wherein said plug of said free end of said plug cord of said earbuds and plug retractor assembly is for selectively connecting to the wireless mobile phone; and
wherein said spring-biased and ratcheted reel of said earbuds and plug retractor assembly selectively and windingly retracts and unwindingly extends said pair of earbud cords of said earbuds and plug retractor assembly and said plug cord of said earbuds and plug retractor assembly.

14. The case of claim 13, wherein said earbuds and plug retractor assembly includes a housing.

15. The case of claim 14, wherein said earbuds and plug retractor assembly includes a coil spring.

16. The case of claim 15, wherein said earbuds and plug retractor assembly includes a ratchet.

17. The case of claim 16, wherein said coil spring of said earbuds and plug retractor assembly and said ratchet of said earbuds and plug retractor assembly are contained within said housing of said earbuds and plug retractor assembly.

18. The case of claim 16, wherein said coil spring of said earbuds and plug retractor assembly and said ratchet of said earbuds and plug retractor assembly are operatively connected to said spring-biased and ratcheted reel of said earbuds and plug retractor assembly.

19. The case of claim 14, wherein said housing has:
a) a rear wall;
b) a pair of side walls;
c) a top wall;
d) a bottom wall; and
e) an open front.

20. The case of claim 19, wherein said earbuds and plug retractor assembly has a mounting plate.

21. The case of claim 20, wherein said mounting plate of said earbuds and plug retractor assembly depends from said bottom wall of said housing.

22. The case of claim 20, wherein said mounting plate of said earbuds and plug retractor assembly is generally coplanar with said rear wall of said housing.

23. The case of claim 20, wherein said housing of said earbuds and plug retractor assembly is replaceably attached to said mounting plate of said earbuds and plug retractor assembly, and is thereby external to said housing, by a pair of mating snap parts.

24. The case of claim 23, wherein one of said pair of mating snap parts of said earbuds and plug retractor assembly is affixed to said mounting plate of said earbuds and plug retractor assembly, generally centered thereon, while the other of said pair of mating snap parts of said earbuds and plug retractor assembly is affixed to said housing of said earbuds and plug retractor assembly.
